(19) United States
(12) Patent Application Publication
(10) Pub. No.: US 2019/0143441 A1
(43) Pub. Date: May 16, 2019

(54) JOINING HEAD AND JOINING DEVICE WITH REDUCED INTERFERING CONTOUR

(71) Applicant: NEWFREY LLC, New Britain, CT (US)

(72) Inventors: Christoph EISENBERG, Giessen (DE); Jochen HAIN, Giessen (DE); Nicolas NAB, Giessen (DE); Wolfgang OBERMANN, Giessen (DE); Michael SCHNEIDER, Giessen (DE)

(21) Appl. No.: 16/245,580

(22) Filed: Jan. 11, 2019

Related U.S. Application Data
(63) Continuation of application No. PCT/EP2017/067469, filed on Jul. 11, 2017.

(30) Foreign Application Priority Data
Jul. 13, 2016 (DE) 202016112861.9

(51) Int. Cl. B23K 11/00; B23K 11/36; B23K 9/20; B23K 9/32; F15B 15/00

(52) U.S. Cl. CPC B23K 11/0053; B23K 11/36; F15B 15/00; B23K 9/32; B23K 9/20

(57) ABSTRACT

A joining head for the joining of a joining element to a workpiece, wherein the joining head) has a fluid cylinder that acts in an axial direction for actuating a loading pin, and the fluid cylinder has a cross-sectional area and defines a dimension of the joining head in a predetermined radial direction, and the cross-sectional area of the fluid cylinder deviates from a circular shape in order to reduce the dimension of the joining head in the predetermined radial direction.

### CROSS-REFERENCE TO RELATED APPLICATIONS

This application is a continuation of international application PCT/EP2017/067469, filed Jul. 11, 2017 which claims priority from German Patent Application No. 102016112861.9 filed Jul. 13, 2016, the disclosures of which are incorporated herein by reference in their entirety.

### BACKGROUND OF THE INVENTION

A joining head for the joining of a joining element to a workpiece, wherein the joining head has a fluid cylinder (or actuator or loading pin cylinder) that acts in an axial direction for actuating a loading pin, wherein the fluid cylinder has a cross-sectional area and defines a dimension of the joining head in a predetermined radial direction.

The fluid cylinder defines the dimension of the joining head directly or indirectly, wherein what is meant by a direct definition is that an outer wall of the fluid cylinder corresponds to an outer wall of the joining head, and wherein what is meant by an indirect definition is that an outer wall of the fluid cylinder is surrounded by a wall of the joining head, which wall is thus formed correspondingly to the radial extension of the fluid cylinder.

A joining head of the aforementioned type can be used in so-called stud welding, for example. In stud welding, fastening elements or joining elements such as studs, bolts, nuts, or balls are welded substantially perpendicularly onto a surface of a workpiece, for example a vehicle body panel.

Stud welding is preferably carried out in automated fashion by a joining device and is widely used in the vehicle body construction area, wherein the fastening elements joined to a workpiece in this manner preferably serve as fasteners or anchors for interior trim components or clips, onto which wires, fuel lines, brake lines, etc. can then be fastened.

A joining head preferably has feed or supply lines for joining elements, for control signals, for the welding current and compressed air, for the loading pin, which is operatively connected to the fluid cylinder, for a receptacle or receiving portion, which is connected to a joining element feed line, and for a joining element holder with a clamping mechanism.

During the joining process, a joining element is first provided in, preferably injected into or blown into, the receptacle or receiving portion. This joining element is then pushed by means of the loading pin actuated by the fluid cylinder from a stand-by position in the receptacle into a joining position in the joining element holder. In this process the joining element is clamped by a clamping mechanism or clamping portion of the joining element holder and braced by the loading pin. In doing so the loading pin moves along a loading pin axis in a joining direction. The joining head can now be moved in the joining direction in order to join the joining element located in the joining position to a workpiece.

It is also conceivable for the joining head to have an actuator-operated pincer (or claw) mechanism for holding a joining element. In this case the joining element can be gripped by the joining head, specifically by the pincer (or claw) mechanism, and then joined in a manner already known from the prior art. With a joining head that has a pincer mechanism, it is possible to pick joining elements from a joining element supply. It is thus possible to dispense with infeeding by compressed air. However, it is also possible to supply joining elements to a joining head having a pincer mechanism in the manner described above.

In order to be able to brace or support the joining element sufficiently and adequately during a joining process as well as apply a sufficient axial force in the joining direction, which is needed to press the joining element into the clamping device, a fluid cylinder with a correspondingly large cross-sectional area is needed for actuating the loading pin. This cross-sectional area thus directly or indirectly defines the radial dimension of the joining head in at least one predetermined radial direction.

With the joining of a joining element to a workpiece, in particular with the welding of a stud or bolt to a vehicle body panel, it is sometimes desirable to join a joining element as close as possible to an end wall (or an edge) of the workpiece. In this case the aforementioned radial dimension of the joining head that is directly or indirectly defined by the fluid cylinder forms an interfering contour. There is therefore a need to reduce the distance between the joined joining element and the end wall or edge of the workpiece, without reducing the axial force in the joining direction applied by the fluid cylinder (or by a piston of the fluid cylinder).

The present invention addresses the object of providing an improved joining head and joining device, in particular a joining head or joining device with which joining in proximity to an end wall of a workpiece is possible.

### BRIEF SUMMARY OF THE INVENTION

This object is solved with the aforementioned joining head in that, in order to reduce the dimension of the joining head in the predetermined radial direction, the cross-sectional area of the fluid cylinder deviates from a circular shape. The fluid cylinder may also be an actuator or a loading pin cylinder.

In other words, the cross-sectional area differs from a circular shape, such that the cross-sectional area has a dimension that is smaller in the predetermined radial direction than in a direction perpendicular thereto. Thus, the cross-sectional area of the fluid cylinder com-prises a first length in the predetermined radial direction and a second length in a direction perpendicular to the predetermined radial direction, the first length being smaller than the second length. The total surface of the cross-section is maintained and not reduced with regard to the fluid cylinder of the prior art. Thus, the loading forces stay constant and no additional or specific adjustments are needed.

Possible cross-sectional area shapes include an elliptical shape, an oval shape or a rectangular shape, without limiting the present invention to these.

In a preferred embodiment, which in combination with the preamble of claim 1 constitutes a separate invention, the loading pin of the joining head is arranged offset in the predetermined radial direction in relation to a centre of the associated fluid cylinder, in order to make joining in closer proximity to an end wall of a workpiece possible.

The distance between a joined joining element and the end wall of the workpiece can be further reduced in this manner. The total surface of the cross-section is maintained and not reduced with regard to the fluid cylinder of the prior art. Thus, the loading forces stay constant and no additional or specific adjustments are needed.

The object is furthermore solved by a joining device with a joining head, in particular a joining head as described above, wherein the joining head has a fluid cylinder that acts in an axial direction for actuating a loading pin, wherein the fluid cylinder has a cross-sectional area and defines a dimension of the joining head directly or indirectly in a predetermined radial direction, wherein the cross-sectional area of the fluid cylinder deviates (or differs) from a circular shape in order to reduce the dimension of the joining head in the predetermined radial direction, and/or wherein the loading pin of the joining head is arranged offset in the radial direction relative to a centre of the associated fluid cylinder in order to make joining in closer proximity to an end wall of a workpiece possible.

The basic concept of the present invention thus lies in providing a modified fluid cylinder for a joining head, such that the joining head has a small interfering contour relative to an end wall in the predetermined radial dimension, or rather makes joining in closer proximity to an end wall of a workpiece possible without limiting the axial forces or load forces of the fluid cylinder or its piston.

The term “joining” is understood here to mean in particular a welding procedure in which the joining or rather welding surfaces of the joining element and/or those of the workpiece are made molten, such that when joined together, the molten areas of the welding surfaces fuse into a composite melt, which after cooling provides a substance-to-substance bond.

However, joining can also be understood in general to mean a technique in which only one of the welding surfaces is made molten. Joining can furthermore be understood to mean the bonding or gluing of joining elements to a workpiece, wherein preferably a pre-applied adhesive is made molten on a joining element by heating and then cured. In addition, joining can also be understood to mean a riveting technique.

The object is fully solved.

The fluid cylinder is preferably arranged radially on the outside of the joining head in order to obtain a small distance between the interfering contour of the joining head and an end wall (or an edge) of the workpiece.

In a preferred embodiment, the fluid cylinder has a preventative mechanism for preventing a self-locking of the fluid cylinder, wherein the preventative mechanism at least partially compensates for a pull-out torque (or tilting moment) arising from an eccentric load on a piston of the fluid cylinder. The shape of the piston can remain unchanged with regard to the current joining heads and devices. The drawbacks of not having a centred fluid cylinder are thus mitigated.

Such a preventative mechanism can be achieved by, for example, guides on the cylinder wall or by disposing at least one or a plurality of O-rings between an inner cylinder wall and an outer wall of the fluid cylinder piston, or by a magnetic assembly (with magnetic means) of the fluid cylinder piston.

The joining head can thus be embodied in a form that is generally more durable and less prone to malfunction.

Even though the automated joining of joining elements is mainly discussed here, the invention is in no way limited thereto. The proposed joining head can also be used in a manually operated joining device or joining gun, without exceeding the scope of the present invention.

The present invention preferably relates to a rectangular or oval loading pin cylinder for a joining head, preferably for a stud welding mechanism. According to the prior art, fastening elements are loaded into a joining element holder by a loading pin with a round piston or loading pin cylinder.

The round cross-sectional area and the centric structure give rise to the following disadvantage: a measurement D1 from the centre of the joining element holder to an outside edge of the fluid cylinder determines the distance of a joining element to an interfering contour or end wall of the workpiece. In practice this measurement D1 should be as small as possible.

The present invention proposes using a rectangular or oval loading pin cylinder or fluid cylinder rather than a round one. The measurement D1 can thus be reduced substantially for the same piston surface. The piston is furthermore secured against twisting in the cylinder by the non-round shape.

By reducing the end-side interfering contour of the joining head, joining elements can be joined in closer proximity to an end wall or edge of a workpiece. Furthermore, a position-oriented welding of the joining elements is possible with a form-fitting or contour-adapted configuration of the loading pin.

The present invention furthermore proposes providing a loading pin arranged eccentrically; i.e., off-centred. This not only makes it possible to reduce the measurement D1 but also the end-side interfering contour of the joining head.

In the prior art, the loading pin is generally actuated by a fluid cylinder, wherein the cylinder is circular in cross section and has a piston area that is adapted to the available fluid pressure in order to move the loading pin with a predefined force in the joining direction.

The predefined force arises from the fact that the joining element holder is configured radially elastically and relatively rigidly on its front end in the joining direction, such that the joining element holder is pressed radially over a large area and with a relatively high pressure against the outside of the joining element in this zone. Since a contact resistance between the joining element holder and the joining element should be kept as small as possible, preference is given to supplying a welding current via this area.

Owing to the high rigidity of the radially elastic elements, a relatively high axial force must be applied in order to press a joining element through the joining element holder. This force is generated by the fluid cylinder, which owing to the high axial force has a correspondingly large piston cross section.

Obviously the aforementioned features and the ones that shall be explained further below can not only be used in each specified combination, but also in other combinations or alone without exceeding the scope of the present invention.

### BRIEF DESCRIPTION OF THE DRAWINGS

Exemplary embodiments of the invention are depicted in the drawings and shall be explained in more detail in the following description.

FIG. 1 schematically depicts a joining head prior to a process of joining a joining element to a workpiece.

FIG. 2 shows schematic cross sections of three different joining heads.

FIG. 3 shows a simplified cross section of a joining head along a joining axis, with a fluid cylinder depicted in simplified form.

FIG. 4 schematically depicts a portion of a fluid cylinder.

### DETAILED DESCRIPTION OF THE PREFERRED EMBODIMENTS

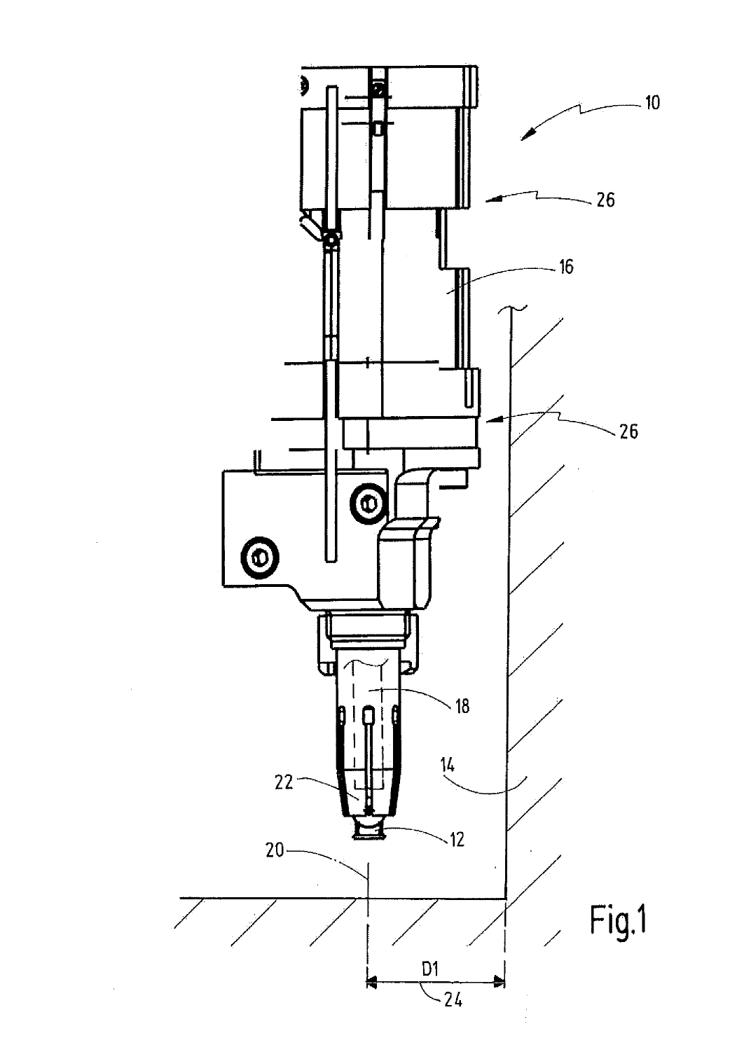

FIG. 1 shows a joining head 10 for joining a joining element 12 to a workpiece 14. The joining head 10 has a fluid cylinder 16 for actuating a loading pin 18, wherein the loading pin 18 can be moved along a joining axis or loading pin axis 20. The joining head 10 also has a joining element holder 22, in which the joining element 12 is held. The workpiece 14 has an end wall or edge extending at a distance D1 from the joining axis or loading pin axis. This distance is designated with the reference number 24 in the drawing. The distance D1 is substantially determined by an interfering contour 26 of the joining head 10, wherein the interfering contour; i.e., the radial dimension in a predetermined radial direction, is fundamentally defined directly or indirectly by a diameter of the fluid cylinder 16.

A joining process works as follows: a joining element 12 is firstly blown into a receiving portion or receiving mechanism, which is not illustrated in any further detail here. Feeding hoses as well as the connectors and lines for control signals, compressed air and welding current are not depicted in the drawings for the sake of clarity. The joining element 12 is then pressed with the loading pin 18 actuated by the fluid cylinder 16 from the receiving portion, along the loading pin axis 20, into the joining element holder 22 and held in the joining position in a clamping portion or clamping mechanism of the joining element holder 22. The joining head 10 can subsequently be moved in the joining direction and a welding current applied such that an arc is struck between the joining element 12 and the workpiece 14. The welding surface of the joining element 12 and/or that of the work-piece 14 are substantially made molten by the arc, such that when joined together, the molten areas fuse into a composite melt, which after cooling provides a substance-to-substance bond.

However, joining can generally also be understood to mean a technique in which only one of the welding surfaces is made molten. Furthermore, joining can also be understood to mean the bonding of joining elements 12 to a workpiece 14, wherein a pre-applied adhesive is preferably made molten on a joining element 12 by heating and then cured. In addition, joining can also be understood to mean a riveting technique.

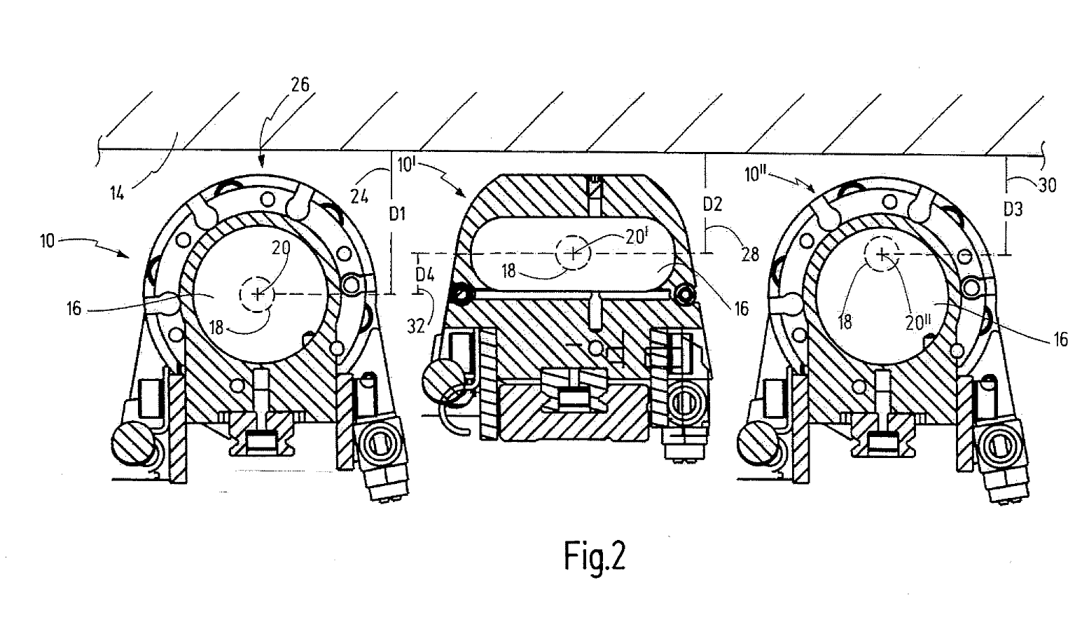

Cross sections of three different joining heads 10, 10′ and 10″ are shown in FIG. 2. The joining head 10 substantially corresponds to the joining head 10 shown in FIG. 1 and known from the prior art. The joining head 10′ has a fluid cylinder 16 with a substantially oval cross section. The joining head 10′ comprises a first length in the predetermined radial direction and a second length in a direction perpendicular to the predetermined radial direction. The first length is, as illustrated, smaller than the second length. The distance D2 to the edge or an end wall of the workpiece is thus directly or indirectly limited by the first length. The oval cross section allows to avoid a rotation of the fluid cylinder in the joining head 10′. This anti-rotation feature enables a joining process of joining elements in a particular orientation. The joining head 10″ has a fluid cylinder 16 in which the loading pin 18 is arranged eccentrically, offset in a predefined radial direction.

This figure can be used to illustrate the advantages of the present invention. To this end, the joining heads 10, 10′ and 10″ are arranged in relation to the workpiece 14 in such a way that a distance between an end wall of the workpiece 14 and the dimension of the respective joining head 10, 10′ and 10″ in the predefined radial direction is equal for each of the joining heads 10, 10′ and 10″. The distance D1 between the loading pin axis 20 and the end wall of the workpiece 14 substantially corresponds to the distance of the centre of a joining element 12 to the end wall of the workpiece 14 after a joining process with the joining head 10. Owing to the fluid cylinder 16 having an oval cross-sectional area, a distance D2 between the loading pin axis 201 and the end face of the workpiece 14, which is designated with 28 in the drawing, is less with the joining head 10′ than with the joining head 10. The distance between the loading pin axis 20″ of the joining head 10″ and the end wall of the workpiece 14 is given by a distance D3, which is designated with 30 in the drawing and which can be equal to or different from the distance D2.

The drawings show a distance D4, which is designated with 32. In the illustrated exemplary embodiments, a joining element 12 can be joined closer (by as much as the distance D4) to the end wall of the workpiece 14 with the joining head 10′, 10″ than with the joining head 10. In FIG. 2, the distance D4 is the same for the joining heads 10′ and 10″. Obviously the distance D4 can also be different.

It is furthermore possible, but for the sake of clarity not shown, to provide a fluid cylinder 16 that has a cross-sectional area deviating from a circular shape, wherein the loading pin 18 is arranged eccentrically on the piston 34 of the fluid cylinder 16. In this manner the distance D4 can be increased further, in other words the distance from the centre of a joining element 12 to the end wall of the workpiece 14 after a joining process can be decreased further. Moreover, with such a joining head 10 it is also conceivable to arrange the loading pin 18 offset in another radial direction perpendicular to the predetermined radial direction, and in this manner obtain an interfering contour reduction in preferably two predetermined radial directions.

This preferred embodiment is advantageous if the workpiece 14 has another end wall perpendicular to a first end wall and joining is to be carried out in a corner of this workpiece 14, which corner is defined by the two end walls.

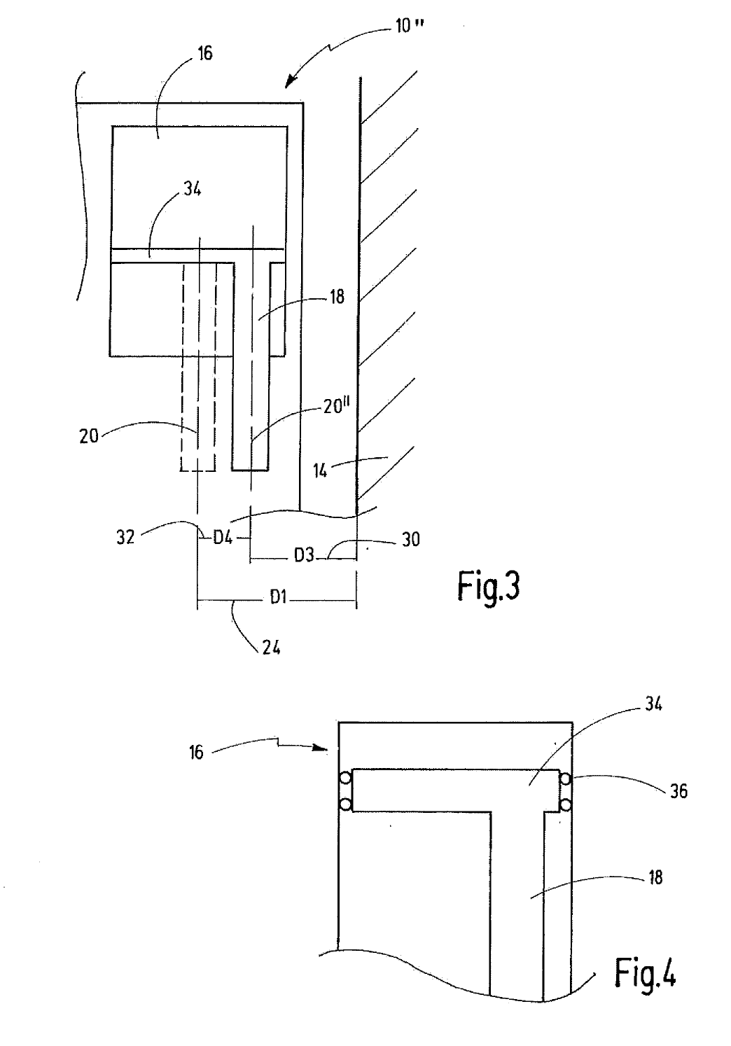

A cross section of the joining head 10″ along a joining axis or loading pin axis 20″ is shown in FIG. 3. The joining head 10″ has the fluid cylinder 16 with a fluid cylinder piston 34, wherein the loading pin 18 is arranged eccentrically offset in the predetermined radial direction. A centric loading pin 18, such as the one that the joining head 10 (as illustrated in FIG. 2 left or FIG. 1) has, is illustrated in dashes in FIG. 3. The offset of the loading pin 18 in the predetermined radial direction defines the distance D4. In other words the offset of the loading pin 18 in the predetermined radial direction directly defines the shortening of the distance between an end wall of the workpiece 14 and the joined joining element 12 after the joining process.

A fluid cylinder 16 is depicted in very simplified form in FIG. 4. The fluid cylinder 16 has the fluid cylinder piston 34 and the eccentrically arranged loading pin 18. A preventative mechanism, is arranged between an inner cylinder wall and an outer wall of the fluid cylinder piston 34. More specifically, in FIG. 4 the preventative mechanism comprises one or several O-ring(s) 36 (or toric joint). As illustrated in FIG. 4, the preventative mechanism comprises two O rings 36. The two O rings are axially spaced from each other and are provided on the outer circumference of the fluid cylinder piston 34. As illustrated the first O ring extends in the vicinity of a first end surface of the piston 34, whereas the second O ring extends in the vicinity of a second end surface of piston 34. The second end surface being opposite the first end surface. The loading pin 18 extends from the second end surface. These O-rings 36 can counteract a tilting moment that can arise due to the eccentric load on the fluid cylinder piston 34.

A joining head 10′; 10″ according to the invention is preferably arranged on a joining device having a multiple axis robot arm. However, provision can also be made for using such a joining head 10′; 10″ in a manual joining device or joining gun.

Preference is given to supplying the welding current via the joining element holder 22, wherein a contact resistance between the joining element holder 22 and the joining element 12 should be as low as possible. Hence the joining element holder 22 is preferably configured as very rigid, thus requiring the application of a strong axial force by the fluid cylinder 16 for pressing the joining element 12 through. The cross-sectional area of the fluid cylin-der 16 is preferably chosen in accordance with the force to be applied.

As a whole the present invention is based on the idea of providing a special fluid cylinder 16 for a joining head 10′, 10″ for actuating a loading pin 18, wherein the fluid cylinder 16 has a cross-sectional area that deviates from a circular shape and/or an eccentrically arranged loading pin 18.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A joining head for the joining of a joining element to a workpiece, wherein the joining head comprises: a fluid cylinder that acts in an axial direction for actuating a loading pin, and the fluid cylinder has a cross-sectional area and defines an access limiting dimension of the joining head in a predetermined radial direction, and wherein the cross-sectional area of the fluid cylinder is not a circular shape in order to reduce the access limiting dimension of the joining head in the predetermined radial direction.

2. A joining head according to claim 1 or according to the preamble of claim 1, wherein the loading pin of the joining head is arranged offset in the predetermined radial direction in relation to a centre of the associated fluid cylinder, in order to make possible joining in closer proximity to an end wall of a workpiece.

3. A joining head according to claim 1, wherein the cross-sectional area of the fluid cylinder comprises a first length in the predetermined radial direction and a second length in a direction perpendicular to the predetermined radial direction, and the first length is smaller than the second length.

4. A joining head according to claim 1, wherein the cross-sectional area of the fluid cylinder comprises one of an ellipse or an oval shape.

5. A joining head according to claim 1, wherein the cross-sectional area of the fluid cylinder comprises a rectangular shape.

6. A joining head according to claim 1, wherein the fluid cylinder is arranged radially on the outside of the joining head.

7. A joining head according to claim 1, wherein the fluid cylinder has a preventative mechanism to prevent a self-locking, and the preventative mechanism at least partially compensates for a tilting moment arising from an eccentric load on a piston of the fluid cylinder.

8. A joining head according to claim 7, wherein the preventative mechanism comprises an O-ring.

9. A joining head according to claim 7, wherein the preventative mechanism comprises a magnet.

10. A joining device for the joining of a joining element to a workpiece, wherein the joining head comprises: a joining head including a fluid cylinder that acts in an axial direction for actuating a loading pin, and the fluid cylinder has a cross-sectional area and defines an access limiting dimension of the joining head in a predetermined radial direction, and the cross-sectional area of the fluid cylinder is not a circular shape in order to reduce the access limiting dimension of the joining head in the predetermined radial direction, or that the loading pin of the joining head is arranged offset in the predetermined radial direction in relation to a centre of the associated fluid cylinder in order to make possible joining in closer proximity to an end wall of a workpiece.

11. A joining device according to claim 10, wherein the joining device is a welding device.

12. A joining head for the joining of a joining element to a workpiece, wherein the joining head comprises:
a fluid cylinder defining a cross-sectional area and including a cylinder wall;
a piston located and operable for axial movement within the fluid cylinder;
a loading pin extending from the piston along a loading pin axis; and
the cross-sectional area partially defines an access limiting dimension of the joining head in a predetermined radial direction, and wherein the loading pin axis is at first distance from the cylinder wall in the predetermined radial direction and the loading pin axis is at a second distance from the cylinder wall in a second radial direction that is not the predetermined radial direction, and the first radius is smaller than the second radius.

13. A joining head according to claim 12 wherein the first distance is a smallest distance between the loading pin axis and the cylinder wall.

14. A joining head according to claim 12 wherein the cross-sectional area of the fluid cylinder is a circular area and the loading pin is located off-center on the piston in the predetermined radial direction.

15. A joining head according to claim 12 wherein the cross-sectional area of the fluid cylinder is a non-circular area.

16. A joining head according to claim 15 wherein the cross-sectional area of the fluid cylinder is one of an oval, or an ellipse, or a rectangle.

17. A joining head according to claim 15, wherein the cross-sectional area of the fluid cylinder defines a first length in the predetermined radial direction and a second length in a direction perpendicular to the predetermined radial direction, and the first length is smaller than the second length.
